(19) United States
(12) Patent Application Publication
(10) Pub. No.: US 2004/0211526 A1
(43) Pub. Date: Oct. 28, 2004

(54) Evaporation method

(76) Inventors: Shu-Wen Chang, Nantou City (TW); Gwo-Sen Lin, Taichung (TW); Chi-Min Chen, Taichung (TW)

Correspondence Address: BIRCH STEWART KOLASCH & BIRCH, PO BOX 747, FALLS CHURCH, VA, 22040-0747, US

(21) Appl. No.: 10/423,896

(22) Filed: Apr. 28, 2003

(51) Int. Cl. B01D 1/22; B01D 9/00

(52) U.S. Cl. 159/49; 159/45; 159/DIG. 16; 159/44; 159/DIG. 10

(57) ABSTRACT

The present invention discloses an improved evaporation method compressing an evaporation material from power into compressed particles or tablets at a predetermined pressure, temperature, and time; since the compressed evaporation material being consistent in crystallization property is more even and denser than powder, therefore the efficiency of the thermal conductivity becomes higher and the efficiency of heating more stable.

### FIELD OF INVENTION

The present invention relates to an improved evaporation method, more particularly to an improved manufacturing method focusing on an evaporation material in powder form used for the evaporation.

### BACKGROUND OF THE INVENTION

In the mechanical, electronic, or semiconductor industries, various methods of producing a coating (a layer of film) on the surface of the applied material to give certain property to the material. If such film is formed by means of the process at atomic level, then such evaporation process is generally called film deposition. The atomic or molecular level controls the evaporation particles to form the coated film, and thus obtaining a coated film with a special structure and function, which cannot be obtained in the thermal equilibrium.

At present, the film deposition is one of the most popular surface treatment methods, which is applicable to the surface treatment for a decoration, tableware, knife, tool, mold, and semiconductor component, etc., generally covering the process of growing a layer of homogeneous or heterogeneous film on the surface of various metal materials, super hard alloys, ceramic materials, and wafer substrates to accomplish the artistic look, wear-resisting, heat-resisting, and corrosion-resisting properties.

The film deposition is divided into physical vapor deposition (PVD) generally called physical deposition, or chemical vapor deposition (CVD) generally called chemical deposition, depending on whether or not the deposition process includes a mechanism of chemical reaction.

The growing of a film is comprised of a series of complicated processes. The single atom that first arrives the evaporation material on the substrate divides the vertical vector so that the single atoms can be “adsorbed” onto the substrate, and such single atoms will form a film required for the chemical reaction on the surface of the substrate. The film constituted of single atoms will diffuse on the surface of the substrate. Such phenomenon is called “Surface Migration” of the adsorbed single atoms. When atoms collide with each other, it will form an atom group and such process is called “Nuclei Formation”. After the atom group reaches a certain size, it will continue to grow steadily. Therefore the small atom group tends to gather and form a larger atom group to reduce the overall energy. The continuous growth of the atom group forms a “Nuclei Island”, and the gap between nuclei islands must be filled with atoms before the nuclei islands can be connected with each other to form a whole continuous film. The atoms that cannot be linked with the substrate will be separated from the surface of the substrate to form a free atom, and such process is called desorption. The difference between the physical vapor deposition (PVD) and chemical vapor deposition (CVD) resides on that the adsorption and desorption of physical vapor deposition is physical adsorption and desorption, and the adsorption and desorption of chemical vapor deposition is chemical adsorption and desorption.

According to the deposition technology and difference of deposition parameter, the structure of the deposited film may be mono-crystalline, polycrystalline, or amorphous structure. Deposition of monocrystalline film plays an important role in the integrated circuit process, which is called “Epitaxial Wafer”. The advantages of the epitaxial growth of semiconductor film over the wafer substrate include the direct doping of the donor or receiver during the deposition process, and thus can accurately control the “Doper Distribution” in the film and does not contain impurities such as oxygen and carbon.

An evaporation method mainly comprise an evaporation chamber for carrying out the evaporation and a vacuum system for providing the vacuity required by the evaporation; in a solid-state deposition material called evaporation material is placed in a crucible in the evaporation chamber, and connected to the direct current outside by such electrically conductive crucible. After an appropriate current passes through the crucible, heat is produced by the crucible due to the resistance effect and the evaporation material in the crucible is heated to a temperature close to the melting point of the evaporation material. At that time, the original solid-state evaporation source has a very strong evaporability, and the atoms of the evaporation material evaporated is used to perform the film deposition on the surface of substrate in the neighborhood above the evaporation source.

In addition the aforementioned vacuum evaporation method, a so-called Electron Beam Evaporation (EBE) is generally used for the evaporation of high-temperature materials. The basic theory is the same as the aforementioned vacuum evaporation method, except that EBE uses electron beam for heating the evaporation material, and the scope of heating is limited to a very small area of the evaporation surface to perform the film deposition, which overcome the shortcomings of the vacuum evaporation method of heating the entire evaporation material.

At present, most evaporation methods fill the powder evaporation material into the crucible and heat the evaporation material under low-pressure environment to achieve the purpose of evaporation. Since the evaporation material is in the form of powder and its structure is looser and has gaps between the powdered particles of the evaporation material, therefore the thermal conduction is poor, particularly under the vacuum condition.

Since the evaporation method fills the powder evaporation material, therefore its structure is looser, and the mass in unit volume is small, therefore it will increase the number of replacing evaporation material. The door of the evaporation chamber must be opened to replace the evaporation material, and thus requiring to lower the temperature and increase the pressure, and then extracting the air to vacuum and increasing the temperature again after the evaporation material is replaced. Such arrangement not only wastes time, but also increases the probability of the manufacturing defects.

### SUMMARY OF THE INVENTION

The primary objective of the present invention is to overcome the above deficiencies and avoid the existing. shortcomings by compressing a powdered evaporation material into a compressed form with predetermined pressure and temperature for the time required. When the compressed evaporation material is evaporated, since the compressed evaporation material is denser than the material in powder form and the evaporation material has more mass in unit volume, therefore it can reduce the number of replacing evaporation materials, and is very helpful in saving the operation time and lowering the probability of manufacturing defects. Since the compressed evaporation material is even and dense, there will be no gaps between the particles of evaporation material and the situation of having poor conduction caused by such gap does not exist at all. In order words, the compressed evaporation material improves the thermal conductivity between the particles of the evaporation material, and speeds up the heat conduction effect, so that the energy for heating can be saved. Furthermore, the compressed evaporation material can be compressed in a way to control its crystalline properties, because the consistency of crystalline properties of the evaporation material gives a more stable heating efficiency, and controls the thickness of the deposited film more accurately.

### BRIEF DESCRIPTION OF THE DRAWINGS

FIG. 1 is a flow chart of the manufacturing procedure of the present invention.

FIG. 2 is an illustrative diagram of the evaporation in accordance with the present invention.

### DETAILED DESCRIPTION OF THE PREFERRED EMBODIMENTS

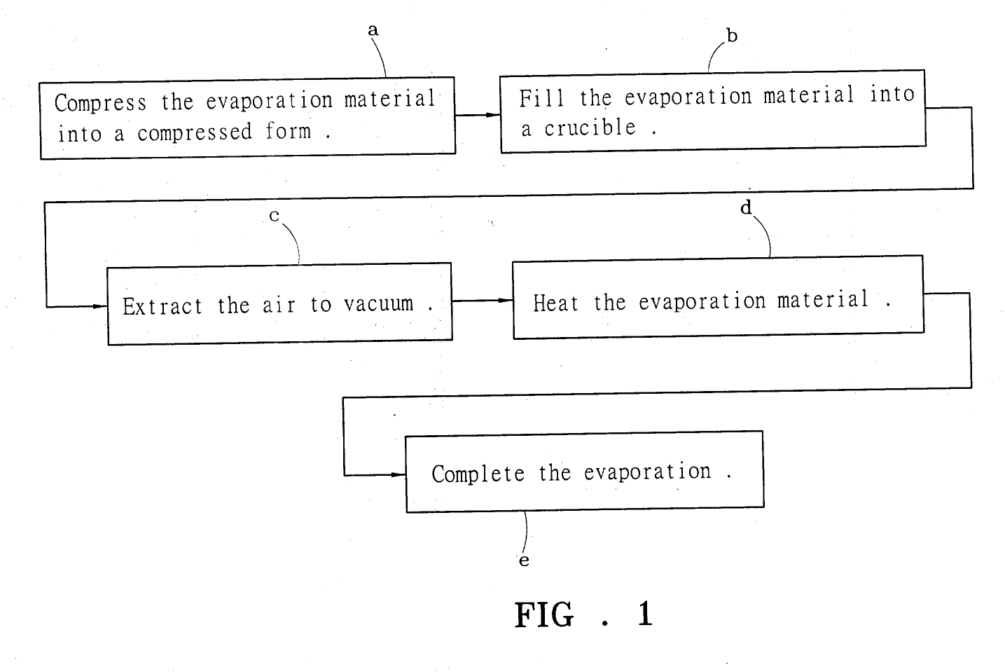

Please refer to FIG. 1 for the flow chart of the manufacturing process of the present invention. The present invention discloses an improved evaporation method compresses an evaporation material 10 in powder form into a compressed format predetermined pressure and temperature for the time required. When the compressed evaporation material 10 is evaporated, since the compressed evaporation material 10 is denser than the evaporation material in powder firm, therefore a crucible 21 in an evaporation chamber 20 can accommodate more mass of evaporation material 10 per unit volume. Furthermore, since the compressed material 10 is even and dense, the thermal conductivity is improved and the heating efficiency tends to be more stable. Such improved evaporation method comprises the steps of:

a. Compressing the evaporation material 10 in powder form into a compressed form at a predetermined pressure and temperature for the time required; wherein the predetermined pressure, predetermine temperature, and required time are respectively set to 5,000 (lbs/in²) to 50,000 (lbs/in²), 20° C. to 120° C., and 20 minutes to 60 minutes; which are adjusted according to the crystalline lattice and density without affecting the properties of the evaporation material 10, and the compressed state could be in a particle form or a tablet form;

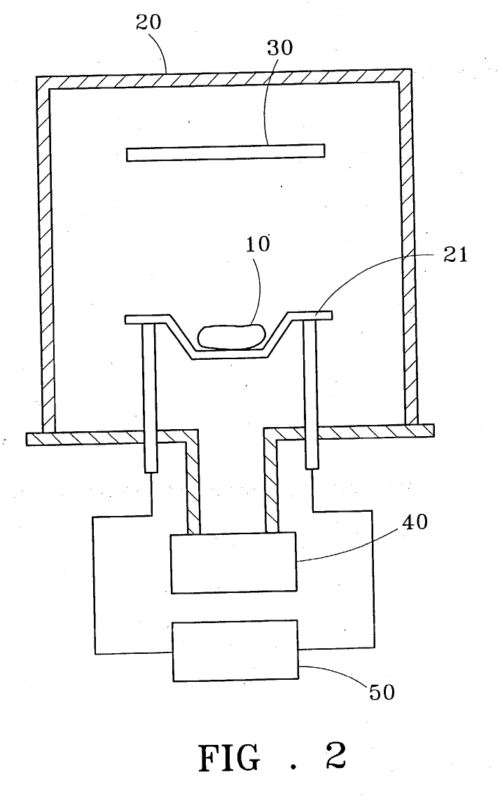

b. Filling evaporation material 10 after compressed by the process described in Step a (refer to FIG. 2 for the illustrative diagram of the present invention) into a crucible 21 in an evaporation chamber 20, and such evaporation chamber 20 includes a substrate 30 that requires to have a coated film;

c. Using a vacuum system 10 to extract the air inside the evaporation chamber 20 to a vacuum state, and such vacuity can be adjusted by the property of the evaporation material 10 and the property of the substrate;

d. Using a heating device 50 to heat the evaporation material 10 according to Step b, such that the evaporation material 10 in the crucible 21 is evaporated into single atoms to the substrate 30; the single atoms are moved on the surface of the substrate 30 or evaporated from the surface of the substrate 30, so that the single atoms on the substrate 30 are collided and combined to form a deposit, and such deposits grow and gather to from a continuous film,

e. Completing the evaporation procedure for forming a required film on the substrate 30.

The evaporation material 10 described in the above procedure is made of a metal, organic, or inorganic material, and such substrate 30 is made of a silicon wafer, metal, organic, or inorganic material. While the present invention has been described in connection with what is considered the most practical and preferred embodiment, it is understood that the invention is not limited to the disclosed embodiments but is intended to cover various arrangements included within the spirit and scope of the broadest interpretation and equivalent arrangements.

What is claimed is:

1. An improved evaporation method compressing an evaporation material from powder into compressed particles or tablets at a predetermined pressure, a predetermined temperature, and a required time; since the compressed evaporation material having a consistent crystallization property and being denser, more even and denser than powder, therefore the efficiency of thermal conductivity becoming higher and the efficiency of heating more stable; wherein said evaporation method comprises the steps of:
a. Compressing an evaporation material from a powder form into a compressed form at a predetermined pressure, temperature, and required time;
b. Filling said evaporation material compressed by the process according to Step a into a crucible in an evaporation chamber, and said evaporation chamber having a substrate requiring to have a film coated by evaporation;
c. Using a vacuum system to extract the air inside said evaporation chamber to a vacuum state, and such vacuity being adjusted according to the properties of said evaporation material and said substrate;
d. Using a heating device to heat said evaporation material according to Step b such that said evaporation material being evaporated into single atoms to said substrate;
e. Completing the evaporation and forming a required film on said substrate.

2. The improved evaporation method of claim 1, wherein said evaporation material is made of a material selected from a collection of metal, organic, and inorganic substances.

3. The improved evaporation method of claim 1, wherein said predetermined pressure is set at a range of 5,000 (lbs/in²) to 50,000 (lbs/in²) and adjusted according to the crystalline lattice and density without affecting the properties of said evaporation material.

4. The improved evaporation method of claim 1, wherein said predetermine temperature is set at a range of 20° C. to 120° C. and adjusted according to the crystalline lattice and density without affecting the properties of said evaporation material.

5. The improved evaporation method of claim 1, wherein said required time is set in a range of 20 minutes to 60 minutes, and adjusted according to the crystalline lattice and density without affecting the properties of said evaporation material.

6. The improved evaporation method of claim 1, wherein said compressed evaporation material is in the form selected from a collection of a particle and a tablet.

7. The improved evaporation method of claim 1, wherein said substrate is made of a substance selected from a collection of a silicon wafer, metal, organic, and inorganic materials.

8. The improved evaporation method of claim 1, wherein said vacuity of the vacuum state is adjusted according to the properties of said evaporation material and said substrate.
